(19) United States
(12) Patent Application Publication
(10) Pub. No.: US 2020/0286199 A1
(43) Pub. Date: Sep. 10, 2020

(54) AUTOMATIC GENERATION OF RIDES FOR RIDESHARING FOR EMPLOYEES OF AN ORGANIZATION BASED ON THEIR HOME AND WORK ADDRESS, USER PREFERENCES

(71) Applicant: Citrix Systems, Inc., Fort Lauderdale, FL (US)

(72) Inventors: Srinivasa Maddipati, San Jose, CA (US); Pranav Kumar Konduru, Sunnyvale, CA (US); FNU Rishabh Sinha, Mountain View, CA (US); Krishna Kumar, Sunnyvale, CA (US)

(21) Appl. No.: 16/295,899

(22) Filed: Mar. 7, 2019

(51) Int. Cl. G06Q 50/30; G06F 16/29; G06Q 10/10; G06N 20/00; G01C 21/34

(52) U.S. Cl. CPC G06Q 50/30; G06F 16/29; G01C 21/3438; G06N 20/00; G06Q 10/1097

(57) ABSTRACT

Systems and methods described herein provide automatic generation of routes and scheduling of rides for ride sharing between users of a same entity based at least on attributes of the users. The server identifies commuting preferences of users of the same entity and whether each of the users prefer to drive or ride. The server receives information identifying a home location and a location of the same entity. The server generates a route for a group of users for commuting by the group of users to the location of the same entity. For the group of users, the server determines a user that is a driver and one or more users that are riders. The server communicates the route information to the group of users.

### FIELD OF THE DISCLOSURE

The present application generally relates to automatically generating rides for ridesharing. Rides can be automatically generated for employees of an organization based on their home and work address and user preferences.

### BACKGROUND

A ridesharing computing system can receive numerous request from computing devices to pick up users of the computing devices from any location, and drop the users off any at any other location. However, there may be a limited number of drivers available to pick users up, or there may be inefficiencies due to the overlapping requests. Due to the large volume of requests for rides received by the ridesharing system, and potentially overlapping rides, it can be challenging for a ridesharing computing system to efficiently generate routes without excess remote procedure calls or processor, memory, or bandwidth utilization. Furthermore, a ridesharing system in which a user can be picked up from anywhere and dropped off anywhere may give rise to safety and security concerns for both the drivers and rides.

### BRIEF SUMMARY

The present disclosure is directed towards systems and methods for automatically generating rides for ridesharing. The present technical solution provides a system having a route manager that can automatically generate efficient routes without excess remote procedure calls or process, memory or bandwidth utilization. The route manager of the present technical solution can generate ridesharing routes for employees of an organization based on the employees' home and work address and user or commuting preferences. By automatically generating a ride for a user without the user requesting a ride, the route manager of the present technical solution can eliminate the need for at least one remote procedure call related to the user requesting a ride.

For example, the route manager of the present technical solution can automatically schedule rides for ridesharing by accounting for user attributes such as home and work location, choice of user to drive or ride on that particular day, distance the user is willing to travel to pick-up another user, time the user wants to leave their origin and traffic information. This information can be obtained from users or clients automatically using machine learning performed by a computing device of the user, or can be otherwise provided by the user.

The route manager of the present technical solution can mitigate, reduce or eliminate inefficiencies, safety issues, or security issues in a ridesharing system by determining that both the driver and rider belong to the same organization or entity. The route manager can automatically generate routes based on user preferences that include, for example, one or more of: i) whether to drive or ride; ii) how much distance or time the user is willing to extend their journey; iii) how many other riders are the user is willing to travel with; iv) what time the user leaves from home or leaves from work; or v) whether the user needs a drive back from work. Based on the user preferences, the route manager can automatically compute the rides for both riders and drivers. The route manager can send the computed ride to the users for their acceptance.

In some cases, the client device used by the user can be configured with on-device machine learning to identify the home and work locations of the user. The server can use the home and work locations of the user to compute the rides on the server. Since the route manager can be configured to limit ridesharing routes to employees of a particular organization, the route manager can provide improved security, safety and privacy relative to systems that are not configured to limit rides to employees of a particular organization. The route manager can provide improved security, safety and privacy because the user location and preferences may not be transmitted to a computer server that is outside the organization (e.g., a third-party server on a public network). Additional sources of information (such as but not limited to active directories, MDM/UEM servers, ERP systems) can be used to fetch information about user preferences and their locations.

At least one aspect of the present technical solution is directed to a method for automatic generation of routes and scheduling of rides for ride sharing between users of a same entity based at least on attributes of the users. The method can include a server identifying commuting preferences of each of a plurality of users of a same entity having one or more locations. Each of the commuting preferences can identify whether a user of the plurality of users specified to drive or ride to the one or more locations of the same entity. The method can include the server receiving, from devices of each of the plurality of users, information. The information can identify for each of the plurality of users a home location and a location of the one or more locations of the same entity. The method can include the server generating a plurality of routes for commuting by the plurality of users to the one or more locations of the same entity based at least on the home location and commuting preferences of each user. Each route of the plurality of routes can correspond to a group of users of the same entity of a plurality of groups of users to commute via each of the plurality of routes to the one or more locations of the same entity. The method can include the server determining, for each group of users for each route of the plurality of routes, a user of each group of users that is a driver and one or more users of each group of users that are riders. The method can include the server communicating, to each of the devices of each of the users in each group of users, route information of each route of the plurality of routes assigned to each group of users of the plurality of groups of users.

Each of the devices can be configured to display and update route information for one or more groups of users and routes to which the user of each of the devices is assigned. The method can include the server identifying that each user of the plurality users is linked to the same entity. The commuting preferences can identify a choice of a user of the plurality of users to drive or ride on one of a particular day of a week or a particular date. The commuting preferences can identify one or more of a boundary condition to perform a pickup, and a departure time from the home location.

The method can include the server receiving commuting preferences of a user from a device of the user. The device of the user can perform machine learning from data of the device to determine one or more preferences of the commuting preferences. The method can include the server receiving a home location of a user and a location of the one or more locations the user commutes to the entity from a device of the user. The device can determine the home location and the location using location data identified by the device.

The method can include the server determining a start time for a rider of each group of users to leave to pick up a rider on the route for the group. The server can determine the start time based on traffic information received by the server. The server can communicate the start time to a device of the user corresponding to the driver for each group. The method can include the server identifying, for one or more users of the plurality of users from one or more servers of the entity one of commuting preferences, home location or the one or more locations for each of the one or more users.

The method can include the server receiving calendar information for each of the plurality of users. The method can include the server generating each route of the plurality of routes corresponding to the group of users based on the calendar information. The server can determine a start time for a rider of each group of users to leave to pick up a rider on the route for the group. The server can determine the start time based on the calendar information. The method can include the server selecting a form of transportation for at least one user of the plurality of users comprising one of drive, ride, or public transportation on one of a particular day of a week or a particular date. The server can select the form of transportation using historical information and a machine learning engine.

At least one aspect of the present technical solution is directed to a system to automatically generate routes and schedule rides for ride sharing between users of a same entity based at least on attributes of the users. The system can include a server comprising one or more processors and memory. The server can include a route manager of a server. The server can be configured to identify commuting preferences of each of a plurality of users of a same entity having one or more locations. Each of the commuting preferences can identify whether a user of the plurality of users specified to drive or ride to the one or more locations of the same entity. The server can receive information identifying for each of the plurality of users a home location and a location of the one or more locations of the same entity. The server can receive the information from devices of each of the plurality of users. The server can generate a plurality of routes for commuting by the plurality of users to the one or more locations of the same entity based at least on the home location and commuting preferences of each user. Each route of the plurality of routes can correspond to a group of users of the same entity of a plurality of groups of users to commute via each of the plurality of routes to the one or more locations of the same entity. The server can determine a user of each group of users that is a driver and one or more users of each group of users that are riders. The server can determine the driver and the riders for each group of users for each route of the plurality of routes. The server can communicate, to each of the devices of each of the users in each group of users, route information of each route of the plurality of routes assigned to each group of users of the plurality of groups of users.

Each of the devices can display and update route information for one or more groups of users and routes to which the user of each of the devices is assigned. The route manager can identify that each user of the plurality users is linked to the same entity. The commuting preferences can identify a choice of a user of the plurality of users to drive or ride on one of a particular day of a week or a particular date. The commuting preferences can identify one or more of a boundary condition to perform a pickup, and a departure time from the home location.

The route manager can receive commuting preferences of a user from a device of the user. The device of the user can perform machine learning from data of the device to determine one or more preferences of the commuting preferences. The route manager can receive a home location of a user and a location of the one or more locations the user commutes to the entity from a device of the user. The device can determine the home location and the location using location data identified by the device.

The route manager can determine a start time for a rider of each group of users to leave to pick up a rider on the route for the group. The route manager can determine the start time based on traffic information received by the server. The route manager can communicate the start time to a device of the user corresponding to the driver for each group.

The route manager can receive calendar information for each of the plurality of users. The route manager can generate each route of the plurality of routes corresponding to the group of users based on the calendar information. The route manager can determine, based on the calendar information, a start time for a rider of each group of users to leave to pick up a rider on the route for the group.

The route manager can select a form of transportation for at least one user of the plurality of users comprising one of drive, ride, or public transportation on one of a particular day of a week or a particular date. The route manager can select the form of transportation using historical information and a machine learning engine.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1 is a block diagram of embodiments of a computing device;

FIG. 2 is a block diagram of an example embodiment of a system to automatically generate rides for ridesharing.

FIG. 3 is an example flow chart of a method for automatically generating rides for ridesharing.

FIG. 4 is an example operation of a system for automatically generating rides for ridesharing.

FIG. 5 is an example operation of a system for automatically generating rides for ridesharing.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein.

Section B describes systems and methods for automatically generating rides for ridesharing.

### A. Computing Environment

Prior to discussing the specifics of embodiments of the systems and methods detailed herein in Section B, it may be helpful to discuss the computing environments in which such embodiments may be deployed.

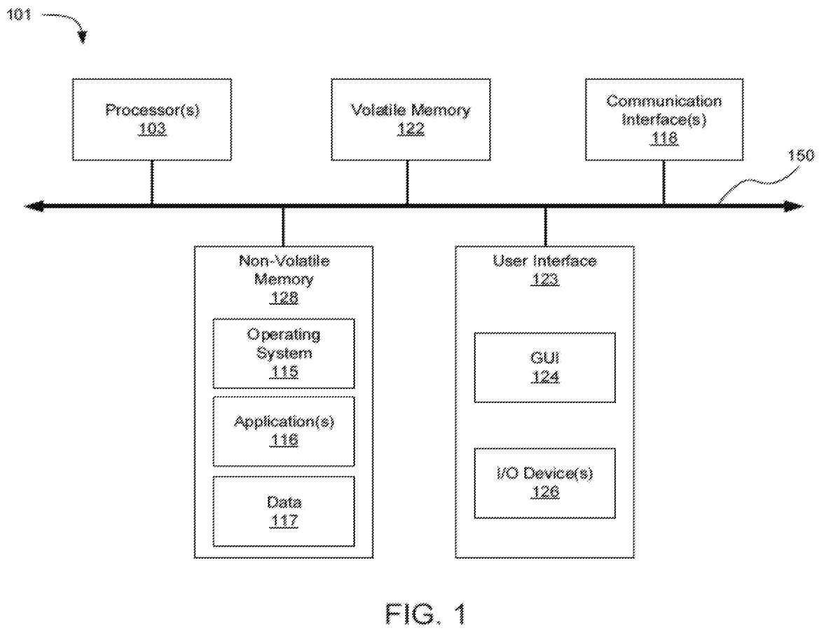

As shown in FIG. 1, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1 is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Additional details of the implementation and operation of network environment, computer 101 and client and server computers may be as described in U.S. Pat. No. 9,538,345, issued Jan. 3, 2017 to Citrix Systems, Inc. of Fort Lauderdale, Fla., the teachings of which are hereby incorporated herein by reference.

### B. Systems and Methods for Automatically Generating Rides for Ridesharing

The present disclosure is directed towards systems and methods for automatically generating rides for ridesharing. The present technical solution provides a system having a route manager that can generate ridesharing routes for employees of an organization based on the employees' home and work address and commuting preferences. By automatically generating a ride for a user without the user requesting a ride, the route manager of the present technical solution can eliminate the need for at least one remote procedure call related to the user requesting a ride.

For example, the route manager of the present technical solution can automatically schedule rides for ridesharing by accounting for user attributes such as home and work location, choice of user to drive or ride on that particular day, distance the user is willing to travel to pick-up another user, time the user wants to leave their origin and traffic information. This information can be obtained from users or clients automatically. For example, a client computing device (or client device) can use machine learning to determine information of or associated with the user. The client device can use machine learning to identify the home location or work location of the user, along with driving patterns or behavior of the user. The client device used by the user can be configured with on-device machine learning to identify the home and work locations of the user. The server can use the home and work locations of the user to compute the rides on the server.

In addition to the information determined via machine learning on the client device, the client device can provide a user interface via which the user can provide additional input. The user interface can include, for example, a graphical user interface, touch interface, or voice-based interface. The client device can receive, via the user interface, input on whether the user prefers to drive or ride on that day, how much distance or time the user is willing to extend their journey to perform a rideshare, how many other users the user is willing to drive with, start times to begin a commute to work from home, leave times to begin a commute from work to home, or whether the user is willing to drive back from work to home or desires a ride back from work. The client device can provide this information to the server. Multiple client devices can each provide this information about a respective user to the server. Additional sources of information (such as but not limited to active directories, MDM/UEM servers, ERP systems) can be used to fetch information about user preferences and their locations. The server can receive this information from each of multiple client devices and use the receive information to generate routes or optimal routes. The server can use the information received from the multiple client devices to match users. The server can determine, identify, or assign users to be drivers or riders. The server can match a user that is a driver with one or more users that are riders. In some cases in which an organization may offer commute services to their employees, the driver can be a permanently designated client device, and all the employees can be automatically assigned to be riders.

Upon matching the driver with one or more riders, the server can transmit drive information or route information to the driver and the one or more riders. The route information can include, for example, a start time, a number of riders, a route, or a potential arrival time at each rider or the final destination. Once the time arrives to drive or ride, the server can transmit a notification the client device. The notification to a driver can include an indication that it is time for the driver to leave their current location and drive to pick up the first rider. The server can determine the start time based on multiple factors, including, for example, traffic conditions, weather conditions, or driving behavior. The server can update the start time periodically, in real-time, or responsive to changes to current conditions (e.g., a change in the traffic condition due to a road construction or a traffic accident).

In some cases, the server can suggest alternate pickup or drive times within a time interval. The server can suggest alternate pickup or drive times based on a condition or event. For example, in the event a user requested or user desired drive or pickup time may not match with an optimal route, the server can suggest an alternate drive or pickup time within a predetermine time interval. For example, a driver can request to depart their home at 8:00 AM and a rider can request to be picked up at 8:15 AM. However, the server can determine that there is road construction being performed on the route between the driver and the rider, or between the rider and the work location. The server can further determine that to avoid excessive delay, it would be optimal for the driver to depart their home at 7:45 AM and pick-up the rider at 8 AM, which may reduce the overall commute time by 30 minutes due to avoiding congestion from increased traffic combined with road construction. The server can further determine that the new optimal times are within a time interval. The time interval can be a time interval input by a user, or preconfigured on the server. The time interval can be 15 minutes, 30 minutes, 45 minutes or some other time interval. The time interval can indicate an interval or range within which the server can suggest an alternate time. Accordingly, the server can suggest an alternate start time to the driver of 7:45 AM instead of AM because it would result in an optimal route and because it is within a predetermined time interval (e.g., 15 minutes from the desired start time). By automatically generating rideshares, the server can generate an improved or optimal route without requiring excessive user input that can reduce transportation times, transportation-related resource utilization, traffic on the roads, and parking congestion at work.

Thus, the route manager of the present technical solution can mitigate, reduce or eliminate inefficiencies in a ridesharing system and safety or security concerns by determining that both the driver and rider belong to the same organization or entity. The route manager can automatically generate routes based on user preferences that include, for example, one or more of: i) whether to drive or ride; ii) how much distance or time the user is willing to extend their journey; iii) how many other riders are the user is willing to travel with; iv) what time the user leaves from home or leaves from work; or v) whether the user needs a drive back from work. Based on the user preferences, the route manager can automatically compute the rides for both riders and drivers. The route manager can send the computed ride to the users for their acceptance.

Systems and methods of the present technical solution can provide these technical improvements and efficiencies, and apply such technical improvements and efficiencies to a ridesharing system, ridesharing infrastructure, or ridesharing platform. For example, the server of the present technical solution can validate client devices based on corporate credentials. The server can validate client devices so that the server may only generate and compute rides for employees of a same organization or entity. By validating client devices, the server can prevent fraud, increase security, or prevent network attacks by preventing malicious client devices or users from accessing the ridesharing functionality provided by the server. After ride sharing is activated or enabled on the server for the validated client device, the server can send a request to each client device. The request can include a request to enable location services or location sharing on the client device. The request can include a request or fetch for additional information. For example, a user of the client device can input information for transmission to the server, or the server can fetch information directly from the client device without or absent additional user input. The information received or obtained by the server can include, for example, one or more of: i) user home location, work location; ii) time to leave for and from work; iii) number of other riders they are willing to travel with; iv) whether the user is willing to drive or ride; v) if driving, the information about the vehicle they will be driving; vi) the previous user behavior, driving patterns and history.

The server can use this information to generate optimal routes for the users. The generated route information can be sent to a client device of a user that is designated as a driver. The user, via the client device, can accept or deny the route. For routes that are accepted, the server can maintain and update the route information until the ride is completed or otherwise terminated.

As the time approaches closer to the ride, the client device can provide to the server any indications of delay on the client-side (e.g., an indication as to whether the driver is ready to depart their home at the start time indicated in the route information). The server can identify traffic patterns, incidents, weather or other possible delays in order to update the route information. The server can send the updated information to the client devices corresponding to the route. The server can continue to update the route information and transmit the route information until the ride corresponding to the route is complete or otherwise terminated. If, however, the server is unable to optimize a route based on received information, the server can determine and suggest an alternate time within a limited time frame to both riders and drivers so as to enable more rides.

The system can include one or more servers configured with a route manager. One or more servers of the system can be or include an endpoint management server, backend server, file server, mail server, web server, organization server, datacenter server, or other type of server or computing device. The one or more servers can be located or associated with a single organization. The one or more servers can be connected via a private or secure network. The endpoint management server can manage mobile client devices of employees that are associated with an organization, company, or other entity. The endpoint management server can provide a client-side route manager, such as an application, interface, agent, or software package or component for installation or execution on the client device. The client-side route manager can interface or communicate with the server-side route manager. The server can be configured to use one or more security or authentication protocols to enforce that only users of the organization are able to request and receive rides with one another. The server can validate the corporate identity before allowing users to user the service, and use the validated identity to match the riders and drivers. Since the route manager can be configured to limit ridesharing routes to employees of a particular organization, the route manager can provide improved security, safety and privacy relative to systems that are not configured to limit rides to employees of a particular organization. The route manager can provide improved security, safety and privacy because the user location and preferences may not be transmitted to a computer server that is outside the organization (e.g., a third-party server on a public network).

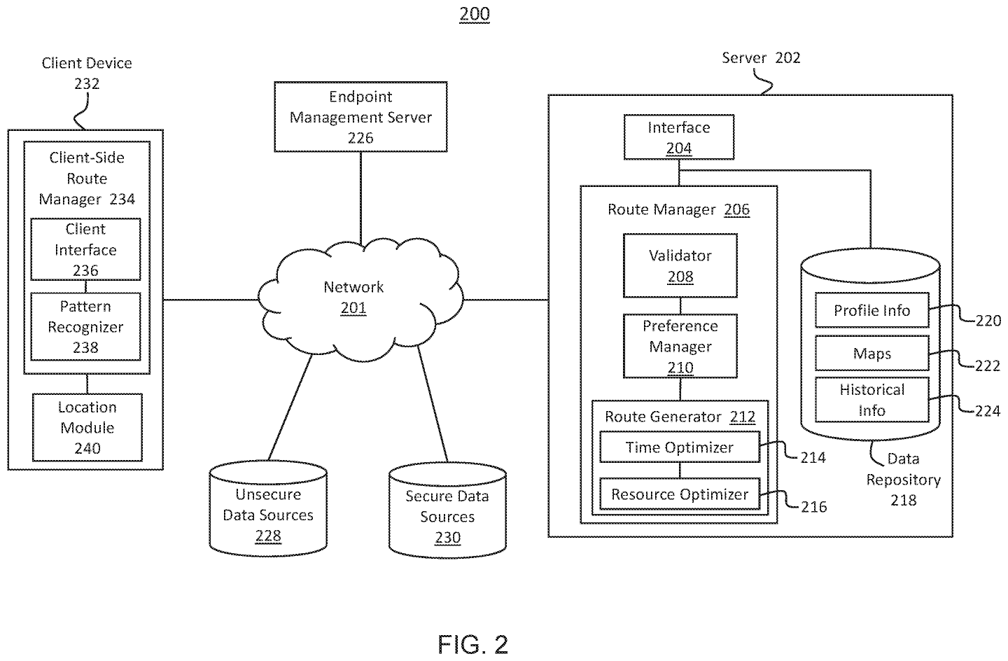

Referring now to FIG. 2, depicted is a block diagram of an example embodiment of a system for automatically generating rides for ridesharing. In brief overview, the system 200 can include a server 202. The server 202 can include one or more component or functionality of system 101 depicted in FIG. 1. The server 202 can include an interface 204 to communicate with one or more system or component of system 200. The server can include a route manager 206. The route manager 206 can be referred to as a server-side route manager. the route manager 206 can include one or more component, module or element configured to perform ride sharing functionality. The route manager 206 can include a validator 208, preference manager 210 and route generator 212. The route generator 212 can include one or more modules or components, such as a time optimizer 214 and a resource optimizer 216. The server 202 can include a data repository 218 to store data, data structures, data files, or databases. The data repository 218 can include profile information 220, maps information 222 or historical information 224. Profile information 220 can include user information, home location, work location, employment status, commuting preferences (e.g., drive or ride, preferred start time, preferred number of people to share a ride with, preferred vehicle type). Maps 222 can include geographic maps, transportation maps, public transportation maps, street maps, traffic maps, or predetermined or generated route maps. Historical information 224 can include information about previous rides or routes. Historical information 224 can be an aggregation of previous rides or routes for a single user or among multiple users. Historical information 224 can include user's driving history data. Historical information 224 can include information associated with the route, such as feedback on the ride (e.g., rating as to whether a user enjoyed the ride or did not enjoy the ride), characteristics associated with the ride (e.g., on time, delayed, smooth ride, fast ride, safe ride, dangerous ride), weather information, etc.

The system 200 can include an endpoint management server 226. In some cases, the server 202 can be separate from the endpoint management server 226. In some cases, the server 202 can include or be the endpoint management server 226. The server 202 can provide one or more functions or include one or more components of an endpoint management server 226.

The system 200 can include or interface with one or more data sources. The system can interface or communicate with data sources via the network 201. For example, the system 200 can interface or communicate with unsecure data sources 228 or secure data sources 230. Unsecure data sources 228 can refer to or include public data sources such a weather data source, traffic data source, road information, census information, or map information. Secure data sources 230 can refer to or include private data sources or protected data sources or data sources controlled, managed, maintained or established by an organization. For example, secure data sources 230 can include a mail server, file server, calendar server, appointment server, or an enterprise resource planning system.

The system 200 can include, interface with or otherwise communicate with a client device 232. The client device 232 can be referred to as a user device, client computing device, computing device, or mobile device. The client device 232 can include, for example, a mobile computing device such as a smartphone, mobile telecommunications device, tablet, wearable computing device, smartwatch, or tablet. The client device 232 can include or execute a client-side route manager 234. The client-side route manager 234 can include or execute a client interface 236 or pattern recognizer 238. The client 232 can include or execute a location module 240.

The server 202, client device 232, unsecure data sources 228, secure data sources 230 or endpoint management server 226 can communicate with one another via network 201. The network 201 can include one or more networks or different types of networks. The network 201 can include a private network such as a local area network (LAN) or a company Intranet, a public network, such as a wide area network (WAN) or the Internet. The networks 201 can employ one or more types of physical networks and/or network topologies, such as wired and/or wireless networks, and can employ one or more communication transport protocols, such as transmission control protocol (TCP), internet protocol (IP), user datagram protocol (UDP) or other similar protocols.

Each of the above-mentioned elements or entities can be implemented in hardware, software or a combination of hardware and software, in one or more embodiments. Each component of the system 200, such as the route manager 206 or client-side route manager 234, can be implemented using hardware or a combination of hardware or software detailed above in connection with FIG. 1. For instance, each of the elements, components or entities shown in FIG. 2 can include any application, program, library, script, task, service, process or any type and form of executable instructions executing on hardware (e.g., of the client device). The hardware includes circuitry such as one or more processors in one or more embodiments.

Still referring to FIG. 2, and in further detail, the system 200 can include, interface with or otherwise communicate with a client device 232. The client device 232 can be associated with an organization, corporation, entity, or account. For example, the client device 232 can be remotely managed, monitored, or controlled by an employer or company via an endpoint management server 226. The client device 232 can include or execute a client-side route manager 234. The client-side route manager 234 can include or execute a client interface 236 or pattern recognizer 238. The client interface 236 can provide, render, or present output to a user of the client device 232. The client interface 236 can include one or more of a communications interface 118 or a user interface 123. The client interface 236 can include or provide a graphical user interface (e.g., GUI 124). The client interface 236 can include or utilize one or more I/O devices 126.

The client-side route manager 234 can receive, via the client interface 236, preferences or attributes associated with the user of the client device 232. The client-side route manager 234 can receive or automatically determine, via machine learning, commuting preferences of the user such as whether the user prefers or wants to drive or ride, start time, arrival time, number of occupants of the car, type of car, boundary condition, duration of the ride, distance willing to travel for a pickup, distance or time they are willing to extend their journey, whether the user is willing to drive back home from work or needs a ride back from work, type of vehicle, vehicle temperature, music preferences (e.g., no music, talk radio, news, pop music, etc.), luggage capacity, leg room, or desired passenger seat (e.g., front passenger seat, backseat, third-row seat).

The client device 232 can provide a client interface 236 via which the user can provide input. The client interface 236 can include, for example, a graphical user interface, touch interface, or voice-based interface. The client device 232 can receive, via the client interface 236, input on whether the user prefers to drive or ride on that day, how much distance or time the user is willing to extend their journey to perform a rideshare, how many other users the user is willing to drive with, start times to begin a commute to work from home, leave times to begin a commute from work to home, or whether the user is willing to drive back from work to home or desires a ride back from work. The client device 232 can provide this information to the server 202. Multiple client devices 232 can each provide this information about a respective user to the server 202.

The client-side route manager 234 can receive, via the client interface 236, an indication of the user's home location and work location. Additional commuting preferences can include, for example, whether the user prefers to be a driver or a rider in a rideshare. Preferences can include a desired start time, arrival time, travel time, number of rideshare occupants, or type of vehicle. A user can provide a preference based on a condition, time interval, or event. For example, the client-side route manager 234 can receive, from a user, a preference as to whether to drive or ride on one or more days of the week or a particular day. The client interface 236 can receive an indication from the user as to which days in a week the user prefers to drive, and which days in the week the user prefers to be a rider. The client interface 236 can further receive an indication that the user has no preference as to whether to be a driver or rider for one or more days of a week. In another example, the client-side route manager 234 can be configured to receive a preference of the user to be a driver or a rider based on a weather condition. The preference can include, for example, to be a rider when it is snowing or raining, and be a driver at the remaining times. The preference can include, for example, to be a driver when there is daylight, but a rider when it dark. The preference can include, for example, to be a driver during certain seasons, and a rider in other seasons. The preference can include to be a driver or a rider based on current traffic conditions, road status (e.g., road construction), the number of other users determined to be in the ride share.

The client interface 236 can receive, along with the indication for the preference to be a driver or rider, a weight. The weight can indicate how much the user prefers to be a driver or a rider on a particular day. The weight can indicate a high level of preference or a low level of preference. The weight can be a binary value, scale, range, symbol, or other indicator. For example, the weight can be a scale of 1 to 5, where 1 indicates that the preference of the user is a low preference, and 5 indicates that the user has a high preference. If the user has a high preference to be a driver (e.g., as indicated by a weight of 5), then the server 202 may ensure that the user is assigned to be the driver in the route that is generated for the user. If the user has a high preference to be a rider (e.g., as indicated by a weight of 1), then the server 202 may ensure that the user is assigned to be a rider in a route that is generated for the user. If the user has a preference to be a rider or driver with a weight of 3, then the server 202 can dynamically determine whether to assign the user to be a driver or a rider for a particular route in order to generate the optimal route.

The client-side route manager 234 can receive preferences regarding a boundary condition to perform a pickup. The boundary condition to perform a pickup can refer to how far a driver is willing to drive to pick up a rider. The boundary condition can refer to a distance from the driver's home location that the driver is willing to drive to pick up a rider. The boundary condition can refer to a distance from a portion of a route between the driver's home location and the driver's work location to which the driver is willing to drive to pick up a rider. For example, picking up a rider may result in the driver driving a certain distance away from a direct route from the driver's home location to the driver's work location. This distance can be compared with a user-input boundary condition to determine whether the distance satisfies the boundary condition. If the distance does not satisfy the boundary condition, then the server 202 can determine to prevent the pickup from occurring by not including the rider in the route generated for the driver having the boundary condition.

Additional examples of boundary conditions can include overall distance of the route, distance or time user is willing to extend their journey, percentage increase in distance relative to a direct route from the driver's home to the driver's work location, overall duration of the route, percentage increase in duration of the route relative to a direct route from the driver's home location to the driver's work location. The boundary condition can be a geographic boundary within the driver's home location, such as a radius or time-based boundary around the driver's home location. For example, the boundary condition can be 1 mile (or, e.g., 1.5 miles, 2 miles, 3 miles, 4 miles 5 miles, or more) from the driver's home location, or a 5-minute (or, e.g., 2 minutes, 3 minute, 7 minute, 10 minute, 15 minute or more) drive from the driver's home location. In another example, the boundary condition can be an increase of 15 minutes relative to a direct route from the driver's home location to the driver's work location such that any combination of pickups of riders that would not increase the duration of the route more than 15 minutes relative to a direct, pickup-less route from the driver's home location to the driver's work location is permitted. In some cases, the boundary condition can be a distance boundary around the work location, such as 0.5 miles, 1 mile, 2 miles, 3 miles, or more.

In some cases, boundary conditions can indicate certain roads or types of roads the driver is willing to traverse, or roads or types of roads the driver is unwilling to traverse. For example, the user can indicate, via the client interface 236, a boundary condition that the user is not willing to drive on a type of road such as a toll road, highway, side road, dirt road, unpaved road, etc. The user can indicate, via the client interface 236, geopolitical boundaries, such as cities, town, counties or states as a boundary condition.

The client-side route manager 234 can request or receive preferences related to a departure time from a home location of the user. The departure time can be agnostic to whether the user is a driver or a rider. For example, the client-side route manager 234 can receive a desired departure time of the user that indicates when the user would like to leave their home in order to go to work. The client-side route manager 234 can provide a client interface 236 in which the departure time can be input a single time value, multiple time values, or a time period or time range. The time period or time range can include, for example, a time window during which the user desired to depart from the home location. The time window can be, for example, 7:45 AM to 8 AM, 7:30 AM to 8:15 AM, or some other time window. The departure time window can be input into the client interface 236 as a single time with a margin or buffer, such as 8 AM with a margin of plus or minus 15 minutes. The departure time or time window can be specific to a particular day of the week, particular date, or based on a condition, event or trigger. For example, the departure time can vary based on what type of appointment the user may have (e.g., depart earlier if meeting with boss, depart later if no morning meetings, depart at nominal time if general team meeting).

Thus, the client-side route manager 234 can receive preferences or other information for or associated with the user via the client interface 236. The client-side route manager 234 can provide, transmit, convey or otherwise communicate the preferences to the server-side route manager 206. In some cases, the client-side route manager 234 can determine preferences, attributes or other information of, for or about the user or client device 232 without the user of the client device 232 inputting the information. For example, the client device 232 can include one or more sensors that are designed, constructed or operational to sense, detect, or measure characteristics or physical parameters associated with the client device 232. Sensors can include, for example, an ambient light sensor, temperature sensor, motion sensor, proximity sensor, accelerometer, or gyroscope. The client device 232 can include a location module 240 designed, constructed or operational to determine a location of the client device 232. The location module 240 can determine the location of the client device 232 using a global positioning system (GPS), cell phone triangulation, WIFI triangulation, Bluetooth beacons, or other location detection techniques. The location module 240 can determine location information of the client device 232 with or without the user providing input via client interface 236.

While the client-side route manager 234 can receive or obtain information, preferences or attributes from user input via the client interface 236, the client-side route manager 234 can determine preferences, attributes or information about the user via a machine learning technique. For example, the client-side route manager can include a pattern recognizer 238 designed, constructed or operational to use a machine learning technique to determine a driving behavior, characteristic, preference or attribute associated with the client device 232 or user thereof. The pattern recognizer 238 can be configured with machine learning techniques that can include one or more type of machine learning such as supervised learning, semi-supervised learning, unsupervised learning, or reinforcement learning. The pattern recognizer 238 can be configured with various processes and techniques for performing machine learning, including, for example, one or more of processes and techniques feature learning, sparse dictionary learning, anomaly detection, decision trees, or association rules. The pattern recognizer 238 can use or be configured with various machine learning models including, for example, artificial neural networks, support vector machines, or Bayesian networks. The pattern recognizer 238 can be configured to perform a statistical analysis, such as logistic regression using a logistic function to model a binary dependent variable.

The pattern recognizer 238 can use machine learning or statistical models to determine information, preferences or attributes of the user. The pattern recognizer 238 can determine, for example, a home location of a user, a work location of a user, or an entity of a location to which the user commutes. The pattern recognizer 238 can determine the preferences using data identified, detected, sensed or measured by the client device 232 (e.g., via a sensor of the client device 232 or location module 240). The pattern recognizer 238 can determine a preference based on analyzing user input.

The pattern recognizer 238 can determine a home location and a work location using historical information detected by the client device 232, or one or more sensor or location to module 240 thereof. The pattern recognizer 238 can determine a home location by determining a location of the client 232 for certain time intervals. For example, if the client device 232 is located at the same residential address for a duration greater than a home threshold on a daily basis, or a majority of the days during the week, the client device 232 can determine that is a home location. If the client device 232 is located at a commercial address for a duration of greater than a work threshold for a majority of the days during the week, the pattern recognizer 238 can determine the commercial address to be the work location of the entity. The pattern recognizer 238 can be configured to determine a home location or work location based on time windows. For example, if the pattern recognizer (via location module 240) determines the client device 232 is located at a residential address from 11 PM to 6 AM for a statistically significant number of days during a week or month, then the pattern recognizer 238 can determine that residential address to be the home location. If the pattern recognizer 238 (via location module 240) determines the client device 232 to be located at a commercial address for a duration greater than a work duration during the hours of 9 AM to 5 PM, for example, for a statistically significant number of days during a week or month, then the pattern recognizer 238 can determine that the user's work location or location of the entity is the commercial address.

The pattern recognizer 238 can use machine learning to determine additional preferences or attributes of the user, such as driving patterns or behaviors. For example, the pattern recognizer 238 can determine whether the user prefers to be a driver or rider on a particular day, a distance the user is willing to travel to pick-up another user, or a time the user wants to leave their origin and traffic information. The pattern recognizer 238 can suggest the determined preference or attributes to the user for the user to confirm or accept the preference via the client interface 236.

By performing the machine learning on the client device 232, the pattern recognizer 238 of the present technical solution of system 200 can provide certain technical improvements. For example, by performing the machine learning on the client device 232, the pattern recognizer 238 executing on the client device 232 can conserve or reduce bandwidth utilization because the client device 232 can collect, store, and process the data on the client device 232 itself, rather than transmit the data to the server 202 for further processing. Furthermore, by performing the machine learning on the client device 232, the client device 232 can update the machine learning model on a more frequent basis or responsive to receiving additional data faster than sending the new or updated data to the server 202 via network 201 and waiting for the server 202 to update the model and determine a new home location, work location, or other preference. The pattern recognizer 238, by performing the machine learning on the client device 232, can improve security or privacy by maintaining the data or machine learning model on the client device 232, instead of transmitting the data or machine learning model to the server 202.

In some cases, the server 202 can be configured with a pattern recognizer to perform machine learning to determine one or more user preferences, including for example, a home location, work location, or other preferences.

The system 200 can include a server 202 designed, constructed and operational to automatically generate routes and scheduling for rides for ride sharing between users of a same entity based at least on attributes or preferences of the users. The server 202 can communicate with one or more of the client device 232, unsecure data source 228, secure data source 230, or endpoint management server 226 via network 201. For example, the server 202 can include an interface 204. The interface 204 can include a communication interface 118 or user interface 123 of system 101 depicted in FIG. 1. The interface 204 can be designed, constructed and operational to communicate with one or more component of system 200. For example, the interface 204 can be configured to query unsecure data sources 228 or secure data sources 230 to request, fetch, pull, or otherwise obtain information from the data source. The interface 204 can obtain information from the data sources 228 and 230 on a periodic basis, or responsive to an event, condition or trigger. For example, the interface 204 can request, query or fetch information from one or more of the data sources 228 or 230 based on a time interval such as 15 seconds, 30 seconds, 1 minute, 2 minutes, 3 minutes, 5 minutes, 10 minutes, 15 minutes, 20 minutes, 30 minutes, 1 hour, 6 hours, 12 hours, 24 hours or some other interval. The interface 204 can query, request or fetch information from the data sources 228 or 230 responsive to an event, condition or trigger such as responsive to a request to generate a route, request to update a route, terminate a route, cancel a route, or identifying a new employee to add to the route.

The interface 204 can communicate with data sources 228 or 230 using various network protocols. For example, the interface 204 can communicate with a secure data sources 230 including a mail server using mail server protocol such as post office protocol (POP), post office protocol 3 (POP3), simple mail transfer protocol (SMTP), or internet message access protocol (IMAP). The interface 204 can be configured to communicate with data sources using various communication ports, such as port 25, port 2525, port 465, port 143, port 993, port 110, or port 995.

The interface 204 can be authorized to communicate with the mail server of a specific organization. The interface 204 can be configured with authentication credentials or administrator privileges in order to access information of an organization. The interface 204 can be configured to access information that may not be publicly available, such as a mail server of an organization. The interface 204, therefore, can be located on a secure network or in a secure environment to prevent or mitigate network security attacks or malicious access. The server 202, via the interface 204, can access secure data source 230 to obtain calendar information, contact information, appointment information, meeting room information, or other information of the organization. Such information may not be accessible to third-parties. The server 202, via interface 204, can be configured with administrator privileges established by an information technology protocol or configuration. The server 202 can be configured by a same entity or organization that configured or administers the secure data source 230. The secure data sources 230, in some cases, can be administered, controlled, managed or otherwise maintained by the server 202.

The system 200 can include a route manager 206. The route manager 206 can be designed, constructed or operational to automatically generate routes and scheduling of rides for ride sharing between users of a same entity based at least on attributes of the users. The route manager 206 can include or execute on hardware or software components, including, for example, a hardware processor, processing circuitry, or digital components. The route manager 206 can include or be configured with rules, policies, digital logic, machine learning, neural network or other techniques to automatically generate routes and scheduling of rides.

The route manager 206 can include a validator 208 designed, configured or operational to validate or enroll one or more client devices 232 with the route manager 206. Validation can refer to determining whether the client devices 232, or users thereof, are employees of a predetermined corporation, organization, account, or entity. The validator 208 can validate the client devices based on credentials or authentication information such as a username, account number, employee number, password, or pin. The validator 208 can receive credential or authentication information from the client-side route manager 234 via network 201. The validator 208 can compare the received credentials with the profile information database 220.

The validator 208 can access secure data sources 230 to determine whether the user is associated or linked with an entity. The validator 208 can compare the received information with secure data sources 230 such as an enterprise resource planning system, human resources system, lightweight directory access protocol (LDAP), LDAP database, or database or data repository to determine whether the user is associated with the organization, an employment status or other information used to determine whether to enroll the client device 232 for the ridesharing platform of the organization.

The validator 208 can validate or enroll the client device 232 using a single sign-on (SSO) technique. SSO can refer to a type of access control associated with multiple related software systems. With SSO, the user of the client device 232 can log into the client device 232 or the client-side route manager 234. Logging into the client device 232 or client-side route manager 234 can also grant the user access to functionality of the server-side route manager 206.

The validator 208 can determine whether the client device 232 is linked to a certain entity. The validator 208 can determine whether multiple client devices 232 are linked to the same entity. The validator 208 can further determine whether the client devices 232 are linked to the same location of the entity. The validator 208 can perform a lookup in a database, query a database, reference an index, or otherwise determine whether an identifier associated with a client device 232 or user corresponds to, is associated with, or other matches an identifier of an entity or an identifier of a location of the entity. The validator 208 can store, in data repository 218, profile information 220 for each client device 232, user, or entity. The profile information 220 can include the identifier of the user, as well as an indication of the entity of the user or the work location of the user. The profile information 220 can include an identifier of the entity and a list of users or employees associated with the entity.

The route manager 206 can include a preference manager 210 designed, constructed or operational to determine, manage, maintain, process, or otherwise maintain preferences for a user or an entity. The preference manager 210 can identify commuting preferences of one or more users of the entity. The preference manager 210 can identify preferences for users that have been validated by the validator 208 as being linked with the same entity. The preference manager 210 can identify the preferences by communicating or interfacing with the client-side route manager 234 via network 201. For example, the preference manager 210, via network 201, can request information from the client-side route manager 234. The client-side route manager 234, responsive to the request, can render a user interface via client interface 236. The user can input the request information via client interface 236 of the client device 232. The client device 232 can transmit the inputted information to the preference manager via network 201.

The preference manager 210 can store preferences in a data repository 218. The preference manager 210 can store the preferences in a profile information data structure 220 for one or more users of the same entity. Example preferences can include whether the user prefers or wants to drive or ride, start time, arrival time, number of occupants of the car, type of car, boundary condition, duration of the ride, distance willing to travel for a pickup, distance or time they are willing to extend their journey, whether the user is willing to drive back home from work or needs a ride back from work, type of vehicle, vehicle temperature, music preferences (e.g., no music, talk radio, news, pop music, etc.), luggage capacity, leg room, or desired passenger seat (e.g., front passenger seat, backseat, third-row seat).

The route manager 206 can receive information that identifies for each user a home location and a work location. The work location can refer to a location of an entity, such as a company, organization, or account. The entity can be associated with multiple locations, such as multiple offices of a large company. The route manager 206 can determine which location the user works at or is visiting on a particular day based on input received from the client device 232 or profile information 220 stored in data repository 218.

Upon receiving or identifying preferences of one or more users of one or more client devices 232, the route manager 206 can automatically generate route and schedule rides for ride sharing between the users of the same entity. The ride share can be among users that are travelling to the same location of the same entity. The profile information 220 can include a profile for the entity that indicates the one or more locations of the entity, such as a name of the location, alphanumeric identify of the location of the entity, address of the location of the entity, latitude and longitude coordinates of the location of the entity.

The route manager 206, upon identifying one or more preferences for users linked to a same entity, home locations of the users, and one or more locations of the same entity, can generate one or more routes for commuting by the users to the one or more locations of the same entity. The route manager 206 can include a route generator 212 designed, constructed or operational to generate one or more routes for users to commute to one or more locations of a same entity based on a home location and commuting preferences of each user. The route generator 212 can generate a route for a group of users of the same entity. The route generator 212 can generate a different route for each group of users of the same entity. The route generator 212 can generate a route specific to, tailored to, or customized for a particular group of users of the same entity. Thus, each group of users of the plurality of users of the same entity can use a respective route generated by the route generator 212 to commute to the one or more locations of the same entity.

The route generator 212 can be configured with one or more techniques to determine a path between one or more home locations and a location of an entity. The route generator 212 can be configured with path finding techniques, graph techniques, or optimization techniques. For example, the route generator 212 can be configured with A*, Dijkstra (e.g., a case of A* to find a lowest cost between two nodes when there is a single source), Bellman-Ford, Floyd-Warshall, Prim (e.g., constructing a minimum spanning tree to generate worst/best time for different routes before getting on the road), a greedy algorithm (e.g., a technique configured to make a locally optimal choice at each stage with the goal of finding a globally optimum solution), or jump point search.

For example, the route generator 212 can use Dijkstra's shortest path first (SPF) algorithm, or a variant there of, to determine the shortest path between nodes in a graph. The nodes in the graph can represent road networks. For a given source node, the route generator 212 can identify the shortest path between that node and one or more other nodes in the graph or road network (e.g., maps 222). For example, the source node can represent the driver's home location, while additional nodes can represent pickup locations of riders and a location of the same entity.

The route generator 212 can use one or more techniques or a hybrid technique to determine a route. The route generator 212 can retrieve, process or select from previously calculated paths stored in the data repository 218 (e.g., in maps 222). The route generator 212 can break down a route into shorter routes (e.g., between each pickup). The route generator 212 can use machine learning to determine the route or duration based on vehicle speed during a particular time of day, traffic patterns, weather, type of vehicle being used, or driver behavior.

The route generator 212 can take into account preferences, such as start time, arrival time, number of occupants of the car, type of car, boundary condition, duration of the ride, distance willing to travel for a pickup, distance or time they are willing to extend their journey, whether the user is willing to drive back home from work or needs a ride back from work, type of vehicle, vehicle temperature, music preferences (e.g., no music, talk radio, news, pop music, etc.), luggage capacity, leg room, or desired passenger seat (e.g., front passenger seat, backseat, third-row seat).

For example, the route generator 212 can identify multiple users that are linked with the same entity or company. The route generator 212 can determine the multiple users are linked with the same entity or company via the validator 208. The entity can have multiple locations. The route generator 212 can then determine which of the multiple users are commuting to a same location of the entity. The route generator 212 can generate a first subset of users that contain only users that are commuting to the same location of the entity.

The route generator 212 can then determine a home location for each of the users in the first subset of users that contains only users that are commuting to the same location of the entity. The route generator 212 can then take into account preferences to generate a route for a group of users. The route generator 212 can separate the first subset of users commuting to the same location into multiple groups of users, and generate a route for each group of users. The route generator 212 can separate the first subset of users into groups of users based on home location, or one or more preferences. The route generator 212 can generate groups based on optimal paths to the work location. The route generator 212 can generate groups based on preferences such as preferred departure time, arrival time, or boundary condition.

The route generator 212 can separate the first subset of users into groups of uses based on a preferred departure time, arrival time, or having home locations within a same locality or geographic threshold (e.g., within 1 mile or 5 minutes), or boundary condition. The size of the group can be determined based on a preference of a number of occupants indicated by each user. For example, the first subset of users may have 12 users. Four of the 12 users may have a preferred departure time of 7 AM; another four of the users may have a preferred departure time of 8 AM; and another four of the users may have a preferred departure time of 9 AM. The route generator 212 can generate three groups from the 12 users as follows: a first group of users containing the four users with a preferred departure time of 7 AM; a second group of users containing the four users with the preferred departure time of 8 AM; and a third group of users containing the four users with the preferred departure time of 9 AM.

The route generator 212 can generate groups based on additional preferences such as music preferences, desired passenger seat, vehicle temperature, storage capacity (e.g., for luggage), or preferred type of vehicle. The route generator 212 can generate groups based on employee roles at the entity, titles, departments, job functions, or teams. For example, the route generator 212 can generate a group of users in different departments at the entity in order to facilitate collaboration among the different departments. The route generator 212 can, therefore, generate groups to optimize a path or route to the work location, as well as based on additional factors or preferences. For example, if the route generator 212 identifies multiple potential groupings that each have one or more routes that are comparable to one another (e.g., approximately the same duration, distance, or star time, journey extension), then the route generator 212 can optimize another factor or take into account an additional preference. The route generator 212 can take into account secondary preferences or secondary considerations, such as music preference, departments, etc. in order to select the group.

The route generator 212 can determine for each group of users for each route of the multiple routes a user that is a driver and a user that is a rider. For each of the three groups of users, the route generator 212 can then determine a user that is a driver and then three users that are riders. The route generator 212 can determine which user is the driver based on preferences either provided by the user or determined via machine learning on the client device 232 (e.g., by the pattern recognizer 238) or the server 202. One or more users may have indicated they prefer to be drivers, while one or more users may have indicated they prefer to be riders. In some cases, all users in a group may have indicated a preference to be a driver. The route generator 212 can generate a group such that at least one user of the group prefers to be a driver. In some cases, however, the route generator 212 may generate a group where all of the users preferred to be a rider because generation of such a group would result in the optimal route.

The route generator 212 can determine which user is the driver and which users are the riders for each group based on the home locations of the users in order to generate an optimal route or path. For example, if one or more users that prefer to be riders have home locations that are on the way to the work location for a first user that may prefer to be a driver, the route generator 212 can determine to assign the first user as a driver, and the remaining users as riders.

In some cases, the route generator 212 can determine the driver and the riders based on preferred departure times. If a first user in the group prefers to depart at 8 AM and a second user prefers to depart at 8:15 AM, then the first user can be selected to be the driver and depart at 8 AM and then pick up the second user on the way to the work location around 8:15 AM, making the second user the rider.

The route manager 206 in some cases can determine the preferred start times based on calendar information for each of the users. The route manager 206 can access a secure data source 230, such as a mail server, containing calendar and appointment information for users of the entity. The route manager 206 can determine, based on the appointment information, a work location arrival time for the user. The route manager 206 can generate, for each group of users, the route based on the calendar information. The route manager 206 can determine, based on the calendar information, a start time for a driver of each group of users to leave to pick up a rider on the route for the group. Thus, based on the work location arrival time to attend the appointment for at least one user of the group, the route manager 206 can determine a start time window for the driver of the group.

Upon selecting a group of users and assigning a user in the group to be the driver, and the remaining users in the group to be riders, the route generator 212 can generate route information. Route information can include a departure time, number of occupants, pickup addresses, arrival time, or work location address. Route information can include additional information to facilitate the pickup of a rider, such as pick up the rider by their front door, side door or garage, or to honk the horn when the driver arrives at the rider's home location. The route generator 212 can generate a data structure containing the route information as follows: {departure time; number of occupants; pick up address of next occupant; estimated arrival time}. The route information data structure can include additional information, such as names of the riders, work location, preferences of the riders, weather information, or traffic information.

The route generator 212 can use machine learning to optimize one or more aspects of the routes. For example, the route generator 212 can include a time optimizer 214 designed, constructed and operational to select an optimum start time for the route based on historical traffic data, a user's driving history data, weather data, nearby events data (e.g., sports event, concerts, parades, road constructions, etc.). The time optimizer 214 can select an optimum start time for the route. The start time can refer to or indicate a departure time for the user that is assigned to be the driver for the route. An optimum start time can be selected to reduce an overall duration of the route.

The time optimizer 214 can interface or communicate with unsecure data sources 28 such as a historical traffic data source, weather data source, or events data source. For example, the time optimizer 214 can determine that peak traffic conditions along a portion of the route are from 8 AM to 9 AM. To avoid being stuck in the peak traffic condition, the time optimizer 214 can select a start time for the route that is before the peak traffic time window or after the peak traffic time window. The time optimizer 214 can block the route generator 212 from selecting a start time for the route that falls within the peak traffic time window. The time optimizer 212 can determine that the duration of route may be one hour if the driver departs at 8 AM, but the duration of the route may be 45 minutes if the start time is 7:55 AM. Accordingly, the time optimizer 212 may select a start time of 7:55 AM in order to reduce the duration of the route by 45 minutes. The time optimizer 212 can select the start time of the route based on predetermined constraints or preferences, such as potential departure time windows provided by the users of the group. A user's preference can indicate acceptable departure time windows, such as 7:30 to 8:30 AM. The time optimizer 214 can identify the departure time windows for each user in the group of users in order to select an optimum start time that reduces the duration of the commute.

The time optimizer 214 can select an optimum start time based on weather information. For example, the time optimizer 214 can access a weather data source to determine that a snow storm is likely to begin at 8 AM. Thus, the time optimizer 214 can schedule the start time before the snow storm begins in order to avoid traffic delays. The time optimizer 214 can determine the snow storm is going to last for 1 hour based on the weather data, and schedule the start time such that the group of users arrives at the work location before the snow storm begins, thereby optimizing the route.

The time optimizer 214 can determine that a sporting event is taking place at a large venue along the route using an events data source. The time optimizer 214 can determine that the event begins at 6 PM, which can cause an increase in traffic along a portion of the route as the event attendees arrive at the venue. To avoid getting stuck in the traffic along the portion of the route and extend the duration of commute home, the time optimizer can select an optimum start time that is before attendees of the event arrive on the portion of the route, or after the event begins and the event attendees have left the portion of the route.

The time optimizer 214 can select a start time based on a user's driving history data. For example, the driving history data for a user may indicate that the user drives more slowly in the rain or after dark due to difficulty in seeing the road. Accordingly, the time optimizer 214 can attempt to select a start time to avoid poor visibility conditions. The time optimizer 214 can determine that the driver typically purchases breakfast or coffee on the route. The time optimizer 214 can select an optimum start time to provide time to make a stop for breakfast while reducing the impact the stop may have on the overall duration of the commute.

In some cases, the route generator 212 can include a resource optimizer 216 designed, constructed and operational to optimize an amount of resource consumption for the commute. Resource consumption can refer to or include fuel consumption, battery consumption, or other vehicle wear and tear. The resource optimizer 216 can select a route that can reduce fuel use, battery consumption or wear and tear on components of the vehicle (e.g., breaks, shocks, or tires). The resource optimizer 216 can obtain, from a driving history data source, information about the amount of resources consumed by a vehicle traversing different types of routes in different conditions. For example, the resource optimizer 216 can determine that gas mileage for a vehicle can reduce by 12% when the temperature is lower than 20 degrees Fahrenheit (F). The resource optimizer 216 can determine that the temperature is going to go from 15 degrees F. at 7:30 AM to 30 degrees F. at 7:45 AM. The resource optimizer 216 can then set a start time for the driver of 7:45 AM because the increase in temperature may decrease fuel consumption, thereby optimizing a resource, be within a desired start time window as indicated by user preferences, while also maintaining a duration of the commute.

In another example, the resource optimizer 216 can determine that a first route includes a toll road and a second route includes only toll-free roads. The resource optimizer 216 can determine to select the second route with only toll-free roads in order to reduce cost of the commute. However, the resource optimizer 216 can further determine that the second route may have a longer duration if the start times are the same for the first and second routes, but that the second route may have a similar duration (e.g., within a threshold such as 1%, 2%, 3%, 5%, etc.) if the start time of the second route is 10 minutes earlier, which may be within an acceptable start time window for the driver.

The route generator 212 can select a form of transportation. Forms of transportation to can include a private transportation or public transportation. Private transportation can refer to or include a user driving a vehicle or riding in a vehicle being driven by another user. Public transportation can refer to or include buses, trains, subways, ferries, trolleys, or other forms of transportation that may charge a fair, run on fixed routes, or are made available to the public. The route generator 212 can use machine learning to select a form of transportation to optimize a performance metric, such as time or resource consumption. For example, the route generator 212 can include a time optimizer 214 and a resource optimizer 216 designed, constructed and operational to select a form of transportation to optimize the commute by time and resource (e.g., fuel usage, vehicle wear and tear, battery usage, road usage, cost). The time optimizer 214 and resource optimizer 216 can process historical traffic data, a user's driving history data, weather data, nearby events data (e.g., sports event, concerts, parades, road constructions, etc.), or public transportation routes and cost data.

For example, the route generator 212 can determine that due to a heavy snow storm being forecasted to occur from 7 AM to 10 AM, that driving a vehicle would result in an excessive commute time. However, the route generator 212 can determine that taking the subway, which may have a longer duration in the absence of an adverse weather condition, may be faster during the heavy snow storm as compared to driving. Accordingly, the route generator 212 can determine, based on the weather data, to select the subway public transportation as the form of transportation for a particular day due to the weather forecast.

The route generator 212 can determine to select a form of transportation based on the cost of nearby public transportation as compared to a cost for private transportation. The form of transportation for the user can include one of drive, ride, or public transportation on one of a particular day of a week or a particular date. The cost of public transportation may be greater when there are a group of four users because each user purchases a ticket. However, the cost of carpooling in a single vehicle may not increase substantially when the number of riders increases from zero or three. Accordingly, the cost of the driving in a vehicle may be greater for if there is only one user in the vehicle as compared to public transportations ticket costs, but carpooling in a vehicle with four users may cost less than four users taking public transportation. Accordingly, the route generator 212 can form a group of users that have a home location within a geographic region or radius from one another, generate a route for the group of users, and assign one user as a driver and the remaining three users as riders because it may optimize resources consumption, such as reducing the cost of the commute.

The route manager 206 can transmit or communicate the route information to client devices 232 via interface 204 and via network 201. The route manager 206 can transmit the route information to each client device 232 associated with a user that is in a group of users. The route manager 206 can communicate, to each of the client devices 232 of each of the users in each group of users, route information of each route of the multiple routes assigned to each group of users of the multiple groups of users. Table 1 provides an illustrative example of the route manager 206 matching users with one another to form groups, assigning drivers and riders. and establishing route information.

TABLE 1
Illustrative Example of Route Information
Generated by Route Manager

| | | | Form of | |
|---|---|---|---|---|
| User | Group of | Work | Trans- | |
| Identifier | Users | Location | portation | Route Information |
| User_1 | Group_1 | Location A | Driver | Addresses of users of |
| | | of Entity A | | Group_1 and pickup |
| | | | | order; |
| | | | | Driver start: 7:30 AM; |
| | | | | Work location arrival |
| | | | | time: 8:15 AM |
| User_2 | Group_1 | Location A | Rider | Identify Driver of |
| | | of Entity A | | Group_1 |
| | | | | Rider Pick Up: 7:35 |
| | | | | AM; |
| | | | | Work location arrival |
| | | | | time: 8:15 AM |
| User_3 | Group_1 | Location A | Rider | Identify Driver of |
| | | of Entity A | | Group_1 |
| | | | | Rider Pick Up: 7:40 |
| | | | | AM; Work location |
| | | | | arrival time: 8:15 AM |
| User_4 | Group_1 | Location A | Rider | Identify Driver of |
| | | of Entity A | | Group_1 |
| | | | | Rider Pick Up: 7:45 |
| | | | | AM; Work location |
| | | | | arrival time: 8:15 AM |
| User_5 | Group_2 | Location A | Rider | Identify Driver of |
| | | of Entity A | | Group_2 |
| | | | | Rider Pick Up: 8:10 |
| | | | | AM; Work location |
| | | | | arrival time: 8:45 AM |
| User_6 | Group_2 | Location A | Driver | Addresses of users of |
| | | of Entity A | | Group_2 and pickup |
| | | | | order; |
| | | | | Driver Start: 7:50 AM; |
| | | | | Work location arrival |
| | | | | time: 8:45 AM |
| User_7 | Group_2 | Location A | Rider | Identify Driver of |
| | | of Entity A | | Group_2 |
| | | | | Rider Pick Up: 7:53 |
| | | | | AM; Work location |
| | | | | arrival time: 8:45 AM |
| User_8 | Group_2 | Location A | Rider | Identify Driver of |
| | | of Entity A | | Group_2 |
| | | | | Rider Pick Up: 8:00 |
| | | | | AM; Work location |
| | | | | arrival time: 8:45 AM |
| User_9 | Group_3 | Location B | Rider | Identify Driver of |
| | | of Entity A | | Group_3 |
| | | | | Rider Pick up: 8:05 AM; |
| | | | | Work location arrival |
| | | | | time: 9:00 AM |
| User_10 | Group_3 | Location B | Rider | Identify Driver of |
| | | of Entity A | | Group_3 |
| | | | | Rider Pick Up: 8:10 |
| | | | | AM; Work location |
| | | | | arrival time: 9:00 AM |
| User_11 | Group_3 | Location B | Driver | Addresses of users of |
| | | of Entity A | | Group_3 and pickup |
| | | | | order; |
| | | | | Driver Start: 7:45 AM; |
| | | | | Work location arrival |
| | | | | time: 9:00 AM |
| User_12 | Group_3 | Location B | Rider | Identify Driver of |
| | | of Entity A | | Group_3 |
| | | | | Rider Pick Up: 7:57 |
| | | | | AM; Work location |
| | | | | arrival time: 9:00 AM |

As illustrated in Table 1 above, the route manager 206 can identify twelve users that are linked to the same Entity A. The route manager 206 can further identify a home location and a location of the Entity A for each of the twelve users. For example, for users 1-8, the route manager 206 can identify the work location as Location A of Entity A; for users 9-12 the route manager 206 can identify the work location as Location B of Entity A.

Based on the home location, work location, and preferences of the users, the route manager 206 can generate multiple groups of users. For example, the route manager 206 can generate Group_1 consisting of users 1-4; Group_2 consisting of users 5-8; and Group_3 consisting of users 9-12. The route manager 206 can further determine, for each user in each group, whether the user is a driver or a rider based on the preferences and route optimization factors. For example, the route manager can assign User_1 to be the driver in Group_1; User_6 to be the driver in Group_2; and User_11 to be the driver in Group_3.

The route manager 206 can determine a start time for each user. For the driver, the start time can indicate when the driver is to depart from their home location. For a rider, the start time can indicate when the driver will pick up the rider. The route manager 206 can determine an estimated arrival time at the work location.

The route manager 206 can provide the route information to a client device 232. The route manager 206 can provide the route information to cause the client device 232 to display and update route information for one or more groups of users and routes to which the user of each of the devices is assigned.

The route manager 206 can provide different route information to a user that is a driver as compared to a user that is a rider. For a driver, the route information can include an indication of being the driver and the start time. The route information for the driver can further indicate an estimate arrival time at the work location. The route information for the driver can further indicate the number of riders to pick up, the home locations of the riders, and the order in which to pick up the riders. For riders, the route information can include an indication of being a rider, the time at which the rider will be picked up, an indication of who the driver is, and an estimate arrival time at the work location.

The user of the client device 232 can view the route information. The client device 232, responsive to receipt of the route information, can present, render, display or otherwise output the route information to a user of the client device 232 via client interface 236. The user of the client device 232 can accept or deny the route. For example, the route manager 206 can provide the generated route to the client device 232 with a request or prompt to accept the route. The client device 232 can receive, via client interface 236, an indication as to whether to accept or reject the route. Should the user accept the route, the client device 232 can transmit an indication of the acceptance to the route manager 206. The route manager 206 can then transmit indications to the other users in the same group that a user has accepted the route. If a user rejects the route, then the route manager 206 can receive an indication from the client device 232 of the route rejection.

The route manager 206 can provide a countdown timer to accept or reject the route. The route manager 206 can configure the countdown timer to default to accepting or rejecting the route in the absence of an indication to the contrary. The default can vary depending on whether the user is a driver or a rider. For example, if the user is a driver, then the route manager 206 can transmit the route information and provide the candidate driver with a time interval (e.g., 15 seconds, 30 seconds, 45 seconds, 60 seconds, 90 seconds, 2 minutes, 3 minutes or more) in which to accept the route and accept being assigned the driver. In the event the route manager 206 does not receive an acceptance from the candidate driver, the route manager 206 can determine that the absence of an acceptance is a rejection.

For a user that is assigned to be a rider, the route manager 206 can provide the route information and the rider designation information along with a request to accept the route and grouping. The route manager 206 can provide a time interval within which to accept or reject the route. In the absence of receiving an indication to accept or reject the route, the route manager 206 can determine that the user accepted the route because the user is being picked up. The time interval to accept being picked up can be the same or different from the time interval to accept being a driver. For example, the time interval to reject being a rider can be less than the time interval to accept being a driver.

The route manager 206 can determine and suggest different routes or groupings responsive to receiving a rejection from one or more users of the initially generated group. For example, if the initial candidate driver rejected being the driver, the route manager 206 can select another user in the same group to be the driver, and then change the initial candidate driver to be a rider. The route manager 206 can continue swapping rider and driver designations in the group until a user accepts being a driver. If no user in the group accepts being a driver, then the route manager 206 can replace a user in the group with another user that may accept being a driver or is more likely to accept being a driver based on preferences. Replacing a user or changing a designation of driver to rider can cause the route manager 206 to generate a route, alter the estimated work location time, alter the start time, or adjust or update other route information.

The route manager 206 can determine not to execute the route until all users of a group have accepted the route. By not executing the route until all users have accepted the route, the route manager 206 can reduce computer processing, memory usage, or bandwidth utilization. Further, by not executing the route until all users have accepted, the route manager 206 can reduce vehicle fuel or battery consumption and re-routing.

Responsive to the route manager 206 identifying acceptance of the route from all users in the group, the route manager 206 can execute the route. The route manager 206 can execute the route by providing a notification to the client devices 232 that the route has been confirmed by all users of the group. The route manager 206 can provide a notification of the start time or pick time to the user of the client device 232.

During execution of the route, the route manager 206 can provide real-time updates to the client devices 232. For example, during the commute, the route manager 206 can provide updates based on real-time traffic condition, weather information, or event information. In some cases, the route manager 206 can update an aspect of the route, such as add or remove a user based on a real-time condition, re-order pickups based on the real-time condition, or change the directions based on real-time information.

For example, the route manager 206 can determine that an unexpected real-time condition (e.g., traffic accident) may result in the route being inefficient. To improve the efficiency of the route, the route manager 206 can remove a user being picked up by the driver to allow the driver to circumvent the portion of the route containing the accident. The route manager 206 can then add the dropped user to the route of a different group having a vehicle that happens to be proximate to the dropped user. In some cases, the route manager 206 can determine that the dropped user should chose a different form of transportation, such as a nearby subway train, in order to avoid delays due to the traffic accident. Thus, the route manager 206 can identify and process real-time conditions in order to dynamically update forms of transportations, start times, or groups of users in order to optimize routes used to commute to a work location.

The client device 232 can receive user feedback via client interface 236. The user feedback can indicate or rate one or more aspects of the route or commute. The route manager 206 can process the feedback to facilitate generating new routes for the user. The route manager 206 can update a machine learning model based on the feedback. The route manager 206 can store the feedback as user preferences.

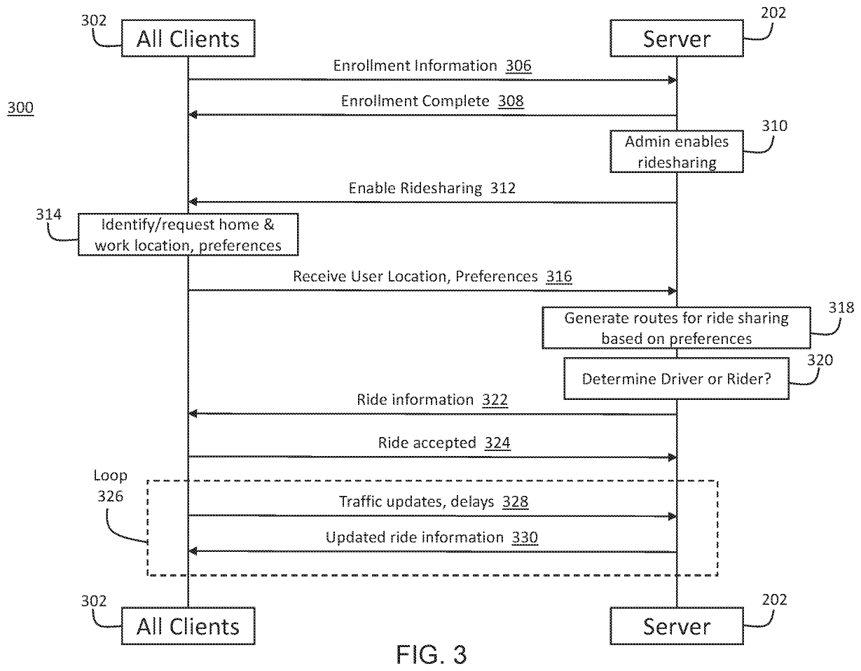

FIG. 3 is an example flow chart of a method for automatically generating rides for ridesharing. The functionalities of method 300 can be implemented using, or performed by, the components depicted and described in FIGS. 1-2. For example, the method 300 can be performed by a server 202, route manager, route generator, all clients 302, or pattern recognizer. The illustrated embodiment of the method 300 is merely an example. Therefore, it should be understood that any of a variety of operations may be omitted, re-sequenced, and/or added while remaining within the scope of the present disclosure.

Clients 302 can refer to or include client devices 232 that are associated or linked with a same entity or same location of the same entity. The clients 302 can provide enrollment information to the server 202 (306). The server 202 (e.g., via a validator) can determine whether the clients 302 are enrolled for the ridesharing functionality. The server 202 can determine whether to enroll the one or more of the clients 302. The server 202 can enroll one or more of the clients 302 based on authentication information or credentials received from one or more of the clients 302. The server 202 can determine to enroll one or more of the clients 302 based on a database or data source of or accessible by the server 202, such as an ERP, human resources system, etc.

The server 202 can transmit an indication that enrollment is complete to one or more of the clients 302 (308). Upon determining that enrollment is complete, the server 202 can enable ridesharing functionality (310). The server 202 can receive an instruction from an administrator of the server 202 or entity to enable ridesharing functionality. Enabling ridesharing functionality can refer to instructing the route manager of the server 202 to automatically generate routes for ride sharing for employees of the same entity. The server 202 can send an indication to the one or more clients 302 that ridesharing has been enabled by the server 202 (312).

The clients 302, upon receiving the indication that ridesharing has been enabled, can provide information to the server 202 to facilitate the automatic generation of routes for ridesharing (314). The server 202 can request information such as the home location, work location or preference associated with users of the clients 302. The clients 302, in some cases, can automatically determine information using machine learning (e.g., determine home location, work location or other preferences). The client 302 can receive, via an input information, information such as preferences. The server 202 can receive the user location and preferences information from the clients 302 (316). The server 202 can receive the information from one or more clients 302 of the same entity. The server 202 can receive the information from each client 302 that has been enrolled for the ridesharing functionality with the server 202 of the same entity.

The server 202 can generate routes for ride sharing based on the received information and preferences (318). The server 202 can generate routes by forming a group of users for a rideshare or carpool and selecting a start time. The server 202 can determine which user in the group of users is a driver, and which users in the group of users is a rider (320). The server 202 can determine rider or driver based on preferences of the users, or to optimize a route. The server 202 can transmit the route information to the clients 302 (322). The server 202 can transmit the route information to each user of the group corresponding to the route. The client 302 can present or display the route information, including the driver or rider designation, to the user of the client 302. The client 302 can provide a mechanism by which the user can accept or reject the route (e.g., graphical user interface element, gesture, touch, motion, or voice input). The server 202 can receive an indication from the client 302 as to whether the route has been accepted by the user (324).

The server 202 can execute the route responsive to the users of the group associated with the route accepting the route. During execution of the route, the server 202 and client 302 can enter a route execution loop 326. In route execution loop 326, the server 202 can receive traffic updates and delay information (328). The server 202 can receive the traffic updates from the clients 302 as detected by the location module of the client device. For example, if the driver was supposed to start at 7:30 AM, but the driver was delayed and did not begin the route until 7:40 AM, the client 302 can transmit an indication of the delayed start to the server 202. The server 202 can then determine updated ride information and provide the updated ride information to the clients 302 of the group (330). Other cause of delay can include traffic, weather delay, stopping for gas or charging a battery of the vehicle, stop for breakfast, or waiting to pick up a rider. The delay information can be provided to the server 202 in real-time or responsive to detection of the delay. The server 202 update the route information or ride information based on the received traffic update, and transmit the ride information to the client 302 in a repeating loop 326 until the ride is complete and the users have reached the work location.

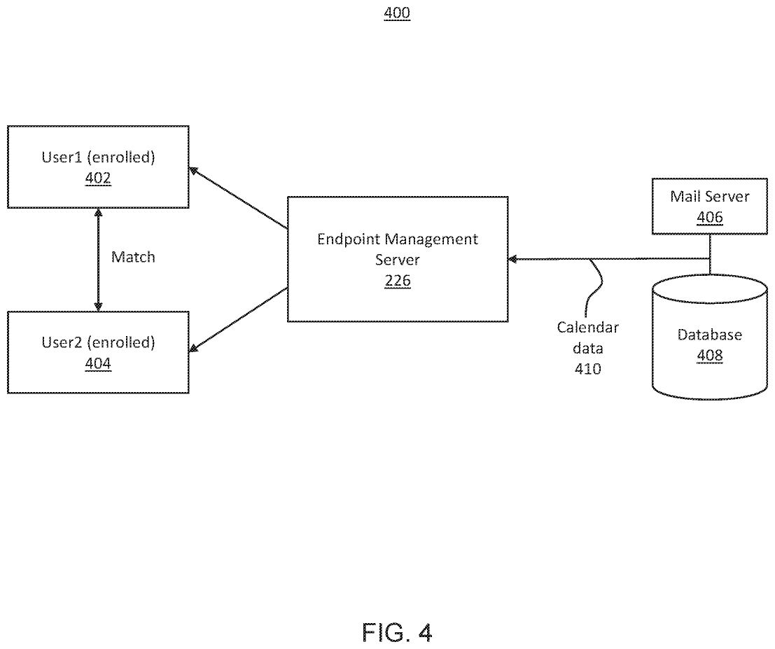

FIG. 4 is an example operation of a system for automatically generating rides for ridesharing. The system 400 can be implemented using the components depicted and described in FIGS. 1-2. The system 400 can include an endpoint management server 226. The endpoint management server 226 can include one or more component, or perform one or more function, of server 202 or route manager 206 depicted in FIG. 2. The endpoint management server 226 can, for example, perform the automatic generation of routes for ridesharing. The endpoint management server 226 can be the same server that remotely monitors, manages or controls employee client devices.

The endpoint management server 226 can obtain calendar data 410 from a mail server 406. The mail server 406 can be associated with the same entity as the endpoint management server 226. The mail server 406 can store the calendar information for users or employees of the same entity in database 408. The endpoint management server 226 can query the mail server 406 to request calendar data 410 for one or more users of the same entity.

The endpoint management server 226 can identified users that are enrolled for the ridesharing program of the same entity. The endpoint management server 226, using information about a home location, work location, preferences, and calendar data 410, can match User1 with User2. The endpoint management server 226 can match User1 with User2 to generate a group of users. The endpoint management server 226 can then generate a route for the group of users consisting of User1 matched with User2. For example, the start time for the driver of the group of users can be determined based on the calendar data 410 that can indicate an appointment for User1 in the morning.

The endpoint management server 226 (or route manager) can use appointment and meeting information from the mail server 406 to determine when User1 is to leave their home to go to the work location. The route manager can create carpool matches (e.g., User1 and User2) for workplace carpooling, depending on whether multiple people living in the same locality attend meetings at a same or similar time, or would like to reach the location of the organization or office at the same time. For example, the endpoint management server 226 can compute the start time for commute to and from the office based on appointment information and meeting information already stored in the mail server 406 at the server end. The endpoint management server 226 can query this information for each user from the client device or from the mail server 406 or other data source. The endpoint management server 226 can manage the employee client device. The endpoint management server 226 can use appointment information or a schedule for a user to compute the start time for commute to and from the office. Further, the endpoint management server 226 can use the appointment information and schedule for all users in an organization to create matches for carpooling because the appointment and schedule information is available on the organization's mail server, calendar server or other server.

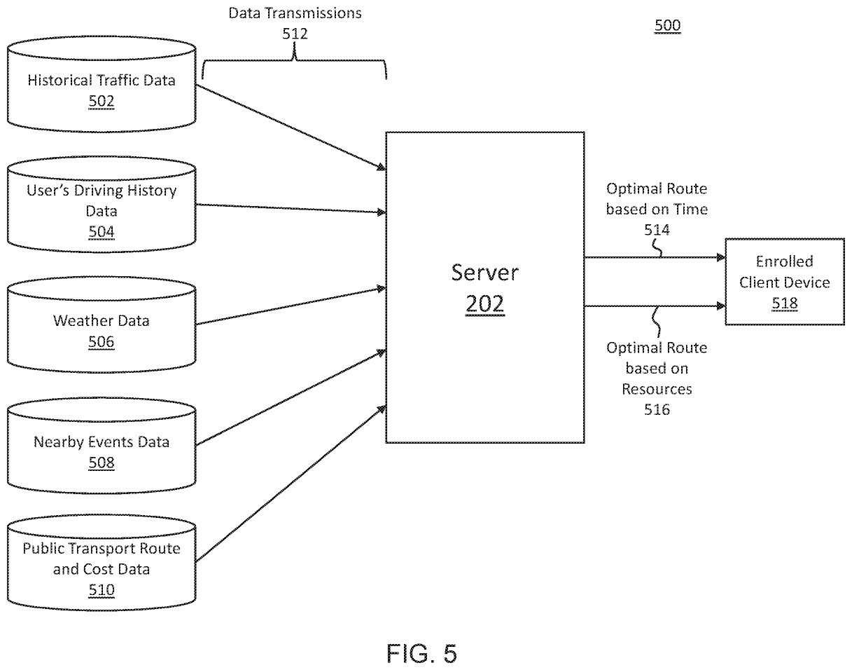

FIG. 5 is an example operation of a system for automatically generating rides for ridesharing. The system 500 can be implemented using the components depicted and described in FIGS. 1-2. The system 500 can include server 202. The server 202 can interface or communicate with an enrolled client device 518. The enrolled client device 518 can refer to client device 232 that has been linked with the same entity and enrolled for ridesharing functionality. The server 202 can interface or communicate with one or more data sources, data repositories, or databases, such as historical traffic data 502, user's driving history data 504, weather data 506, nearby events data 508, and public transport route and cost data 510.

The server 202 (e.g., via a route manager) can select a form of transportation on a particular day, as well as a start time for the commute for an enrolled client device 518. The form of transportation can include, for example, being a driver, rider, or public transportation. The server 202 can select the form of transportation to optimize a performance metric, such as time, computing resources, or financial resources. The server 202 can apply machine learning to historical traffic data, driving history, weather data, nearby events data, and public transport and cost data to select the form of transportation and the start time for the commute.

For example, the server 202 can receive data transmissions from data sources 502-510 (512). The server 202 can receive the data transmissions periodically, in real-time, responsive to an update in a data source or change in an event, or based on some other time interval or condition. The server 202 can determine to generate a route for one or more users of a same entity, which can include selecting a form of transportation for the user. The server 202 can determine a route that optimizes one or more both of time or a resource (e.g., fuel or battery consumption or cost). The server 202 can select an optimal route based on time (e.g., minimum commute time), and transmit the optimal route based on time to the enrolled client device 518 (514). The server 202 can also select an optimal route based on a resource, and transmit the resource-based optimal route to the enrolled client device 518 (516). In some cases, the time-optimized route may be the same as the resource-optimized route. In some cases, the time-optimized route may be different than the resource-optimized route. For example, for a single user that may not be carpooling, the time-optimized route may be to drive. However, due to fuel costs, toll fees, and parking fees, the resource-optimized route for the enrolled client device 518 may be to take public transportation (e.g., subway train). The server 202 can present both options to the enrolled client device 518. The server 202 can further ridesharing options and select an optimum number of riders to result in a route that is optimized for both time and resource consumption.

Thus, the server 202, using data sources 502-510, can predict the optimal form of transportation on a particular day while also determining suggestions for carpooling on a particular day and indicating whether it is optimal to be a driver, be a rider in a carpool, or take public transportation.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for automatic generation of routes and scheduling of rides for ride sharing between users of a same entity based at least on attributes of the users, the method comprising:
(a) identifying, by a server, commuting preferences of each of a plurality of users of a same entity having one or more locations, each of the commuting preferences identifying whether a user of the plurality of users specified to drive or ride to the one or more locations of the same entity;
(b) receiving, by the server from devices of each of the plurality of users, information identifying for each of the plurality of users a home location and a location of the one or more locations of the same entity;
(c) generating, by the server, a plurality of routes for commuting by the plurality of users to the one or more locations of the same entity based at least on the home location and commuting preferences of each user, each route of the plurality of routes corresponding to a group of users of the same entity of a plurality of groups of users to commute via each of the plurality of routes to the one or more locations of the same entity;
(d) determining, by the server, for each group of users for each route of the plurality of routes, a user of each group of users that is a driver and one or more users of each group of users that are riders; and
(e) communicating, by the server, to each of the devices of each of the users in each group of users, route information of each route of the plurality of routes assigned to each group of users of the plurality of groups of users.

2. The method of claim 1, wherein each of the devices is configured to display and update route information for one or more groups of users and routes to which the user of each of the devices is assigned.

3. The method of claim 1, wherein (a) further comprises identifying, by the server, that each user of the plurality users is linked to the same entity.

4. The method of claim 1, wherein the commuting preferences identifies a choice of a user of the plurality of users to drive or ride on one of a particular day of a week or a particular date.

5. The method of claim 1, wherein the commuting preferences identifies one or more of the following: a boundary condition to perform a pickup, and a departure time from the home location.

6. The method of claim 1, wherein (a) further comprises receiving, by the server, commuting preferences of a user from a device of the user, where the device of the user performed machine learning from data of the device to determine one or more preferences of the commuting preferences.

7. The method of claim 1, wherein (b) further comprises receiving, by the server, a home location of a user and a location of the one or more locations the user commutes to the entity from a device of the user, wherein the device determines the home location and the location using location data identified by the device.

8. The method of claim 1, further comprising:
determining, by the server based on traffic information received by the server, a start time for a rider of each group of users to leave to pick up a rider on the route for the group; and
communicating, by the server, the start time to a device of the user corresponding to the driver for each group.

9. The method of claim 1, further comprising:
receiving, by the server, calendar information for each of the plurality of users;
generating, by the server, each route of the plurality of routes corresponding to the group of users based on the calendar information; and
determining, by the server based on the calendar information, a start time for a driver of each group of users to leave to pick up a rider on the route for the group.

10. The method of claim 1, further comprising selecting, by the server using historical information and a machine learning engine, a form of transportation for at least one user of the plurality of users comprising one of drive, ride, or public transportation on one of a particular day of a week or a particular date.

11. A system to automatically generate routes and schedule rides for ride sharing between users of a same entity based at least on attributes of the users, comprising:
a route manager of a server comprising one or more processors and memory configured to:
identify commuting preferences of each of a plurality of users of a same entity having one or more locations, each of the commuting preferences identifying whether a user of the plurality of users specified to drive or ride to the one or more locations of the same entity;
receive, from devices of each of the plurality of users, information identifying for each of the plurality of users a home location and a location of the one or more locations of the same entity;
generate a plurality of routes for commuting by the plurality of users to the one or more locations of the same entity based at least on the home location and commuting preferences of each user, each route of the plurality of routes corresponding to a group of users of the same entity of a plurality of groups of users to commute via each of the plurality of routes to the one or more locations of the same entity;
determine for each group of users for each route of the plurality of routes, a user of each group of users that is a driver and one or more users of each group of users that are riders; and
communicate, to each of the devices of each of the users in each group of users, route information of each route of the plurality of routes assigned to each group of users of the plurality of groups of users.

12. The system of claim 11, wherein each of the devices is configured to display and update route information for one or more groups of users and routes to which the user of each of the devices is assigned.

13. The system of claim 11, wherein the route manager is further configured to:
identify that each user of the plurality users is linked to the same entity.

14. The system of claim 11, wherein the commuting preferences identifies a choice of a user of the plurality of users to drive or ride on one of a particular day of a week or a particular date.

15. The system of claim 11, wherein the commuting preferences identifies one or more of the following: a boundary condition to perform a pickup, and a departure time from the home location.

16. The system of claim 11, wherein the route manager is further configured to:
receive commuting preferences of a user from a device of the user, wherein the device of the user performed machine learning from data of the device to determine one or more preferences of the commuting preferences.

17. The system of claim 11, wherein the route manager is further configured to:
receive a home location of a user and a location of the one or more locations the user commutes to the entity from a device of the user, wherein the device determines the home location and the location using location data identified by the device.

18. The system of claim 11, wherein the route manager is further configured to:
determine, based on traffic information received by the server, a start time for a rider of each group of users to leave to pick up a rider on the route for the group; and
communicate the start time to a device of the user corresponding to the driver for each group.

19. The system of claim 11, wherein the route manager is further configured to:
receive calendar information for each of the plurality of users;
generate each route of the plurality of routes corresponding to the group of users based on the calendar information; and
determine, based on the calendar information, a start time for a driver of each group of users to leave to pick up a rider on the route for the group.

20. The system of claim 11, wherein the route manager is further configured to:
select, using historical information and a machine learning engine, a form of transportation for at least one user of the plurality of users comprising one of drive, ride, or public transportation on one of a particular day of a week or a particular date.
